(19) United States
(12) Patent Application Publication
(10) Pub. No.: US 2012/0007952 A1
(43) Pub. Date: Jan. 12, 2012

(54) RECORDING CONTROL APPARATUS, SEMICONDUCTOR RECORDING APPARATUS, RECORDING SYSTEM, AND NONVOLATILE STORAGE MEDIUM

(75) Inventor: TAKESHI OTSUKA, Hyogo (JP)

(73) Assignee: PANASONIC CORPORATION, Osaka (JP)

(21) Appl. No.: 12/957,689

(22) Filed: Dec. 1, 2010

(30) Foreign Application Priority Data
Jul. 8, 2010 (JP) 2010-155644

(51) Int. Cl. H04N 13/02

(52) U.S. Cl. 348/46; 348/E13.074

(57) ABSTRACT

A recording control apparatus includes an input unit operable to input plural kinds of image data composing a stereoscopic image or a high-definition image, and a recording controller operable to control recording of the plural kinds of image data input by the input unit, to a nonvolatile storage medium. The recording controller controls the recording so that the plural kinds of image data input by the input unit are recorded to different erase blocks of the nonvolatile storage medium in such a manner that different kinds of image data are not mixed in one erase block of the nonvolatile storage medium.

### BACKGROUND

1. Technical Field

The technical field relates to a technique that records/reproduces data of a plurality of images such as three-dimensional (3D) stereoscopic images captured simultaneously to/from a semiconductor recording apparatus such as a memory card.

2. Related Art

Home 3D televisions have come on the market, and interest in 3D images is increasing. In order to produce 3D programs, two cameras are arranged alongside and spaced by a length equal to a gap between right eye and left eye, and image data for right eye and image data for left eye are individually recorded to two VIRs or the like.

JP-A-9-215012 discloses a stereoscopic image capturing apparatus in which two video cameras are arranged with their optical axes being approximately parallel with each other and spaced by a length equal to a gap between right and left eyes. When a three-dimensional stereoscopic image is captured, the images for right and left eyes captured by the two video cameras are simultaneously recorded as two picture signals.

JP-A-2000-270347 discloses a recording apparatus for compressing image data for left eye and image data for right eye and interleaving these image data in predetermined unit to record them to DVD. According to this recording apparatus, both when image data for right and left eyes are reproduced as 3D stereoscopic image and when a 2D image is reproduced by using only one of image data for right and left eyes, real-time reproduction is enabled.

Further, JP-A-2009-147980 discloses an image file generating apparatus included in a digital still camera in which when image data for right and left eyes are recorded to a memory card, the image data for left eye is recorded after first header information and the image data for right eye is recorded after second header information. This image file generating apparatus enables 3D image data to be put into one file while maintaining compatibility with a conventional reproducing device for reproducing 2D image data.

When stereoscopic images are captured, editing operations for deleting some of the images and changing the order of the images are needed after the capturing.

When a 3D stereoscopic image is captured by two imaging devices, editing operations for absorbing color irregularity between the two imaging devices and correcting a field angle are needed after the capturing.

JP-A-2009-147980, however, is described on the assumption that image data is recorded to a memory card, and does not disclose a recording method in which the editing operations are taken into consideration. For example, the following case is examined. After 100 frames of image data with capacity of 1 MB per frame for each of left eye and right eye is recorded in order of left eye and right eye to a memory card, the image data for left eye is corrected to be written back to the memory card. In this case, in the method of J-PA-2009-147980, it is necessary to read the image data for both eyes recorded in one file, correct the data for left eye and afterwards again write the image data for both eyes to the memory card. In such a manner, the image data for right eye that does not have to be corrected should be read and written, and thus time required for the editing operation becomes long, thereby deteriorating the working efficiency.

JP-A-9-215012 and JP-A-2000-270347 are based on VTR and DVD, and do not disclose a technique to record 3D image data in a semiconductor recording apparatus such as a memory card.

### SUMMARY

From a viewpoint of the above problem, it is an object to provide a recording control apparatus, a semiconductor recording apparatus, a recording system and a nonvolatile storage medium which can process and edit plural kinds of image data composing a stereoscopic image efficiently.

In a first aspect, a recording control apparatus is provided. The recording control apparatus includes an input unit operable to input plural kinds of image data composing a stereoscopic image or a high-definition image, and a recording controller operable to control recording of the plural kinds of image data input by the input unit, to a nonvolatile storage medium. The recording controller controls the recording so that the plural kinds of image data input by the input unit are recorded to different erase blocks of the nonvolatile storage medium, in such a manner that different kinds of image data are not mixed in one erase block of the nonvolatile storage medium.

In a second aspect, a semiconductor recording apparatus is provided. The semiconductor recording apparatus includes an input unit operable to input plural kinds of image data composing a stereoscopic image or a high-definition image, and a recording controller operable to control recording of the plural kinds of image data input by the input unit, to a nonvolatile storage medium. The recording controller controls the recording so that the plural kinds of image data input by the input unit are recorded to different erase blocks of the nonvolatile storage medium, in such a manner that different kinds of image data are not mixed in one erase block of the nonvolatile storage medium.

In a third aspect, a recording system having a recording control apparatus and a nonvolatile storage medium is provided. The recording control apparatus includes the recording control apparatus includes an input unit operable to input plural kinds of image data composing a stereoscopic image or a high-definition image, a buffer memory operable to simultaneously store the plural kinds of image data input by the input unit, and a recording controller operable to control recording of data stored in the buffer memory to the nonvolatile storage medium. The recording controller includes a file system unit operable to divide each of the image data on the buffer memory into image data segments with predetermined size and relating the divided image data segments to at least one erase block of the nonvolatile storage medium, and a driver unit operable to divide the image data segments of the plural kinds of image data into a plurality of subsegments, and issue, to the nonvolatile storage medium, a write command for instructing interleaving of the divided subsegments for each kind of images and recording the divided subsegments to the nonvolatile storage medium. The nonvolatile storage medium includes a logical/physical conversion table operable to show a correspondence relationship between logical blocks in which the image data segments are recorded and erase blocks, and a write block controller for secure erase blocks different from erase blocks already registered in the logical/physical table as write blocks of which number is at least the same as the number of the image types based on the write command from the recording control apparatus, and interleave image data segments and record the image data segments of the respective logical blocks to these writing blocks.

In a fourth aspect, a nonvolatile storage medium is provided. In the nonvolatile storage medium, a plurality of kinds of image data composing a stereoscopic image or a high-definition image are recorded in different erase blocks of the nonvolatile storage medium in a manner not to mix them in one erase block of the nonvolatile storage medium.

According to the above respective aspects, plural kinds of image data composing a stereoscopic image or a high-definition image are recorded to different erase blocks of the nonvolatile storage medium so that different kinds of image are not mixed in one erase block of the nonvolatile storage medium. For this reason, when different kinds of image data in the plural kinds of image data composing the stereoscopic image or the high-definition image are processed and edited to be written back, only these image data can be read and written. Therefore, the other image data do not have to be read and written, and thus efficient process and edition are enabled.

### BRIEF DESCRIPTION OF DRAWINGS

FIG. 1 is a configurational diagram illustrating a 3D capturing and recording apparatus according to a first embodiment.

FIG. 2 is a configurational diagram illustrating erase blocks in a flash memory according to the first embodiment.

FIG. 3A is control timing chart of a buffer memory according to the first embodiment (writing of data for right eye to the buffer memory).

FIG. 3B is a control timing chart of the buffer memory according to the first embodiment (writing of data for left eye to the buffer memory).

FIG. 3C is a control timing of the buffer memory according to the first embodiment (reading of the data for right and left eyes from the buffer memory).

FIG. 4A is a diagram illustrating a correspondence relationship between compressed image data for right and left eyes and erase blocks of a memory card according to the first embodiment (data for right eye).

FIG. 4B is a diagram illustrating a correspondence relationship between compressed image data for right and left eyes and erase blocks of the memory card according to the first embodiment (data for left eye).

FIG. 4C is a diagram illustrating a correspondence relationship between compressed image data for right and left eyes and erase blocks of the memory card according to the first embodiment (after writing).

FIG. 5A is a diagram illustrating an arrangement of image data before editing according to the first embodiment.

FIG. 5B is a diagram illustrating an arrangement of the image data after editing according to the first embodiment.

FIG. 6A is a diagram illustrating a conventional arrangement of image data before editing.

FIG. 6B is a diagram illustrating a conventional arrangement of the image data after editing.

FIG. 7 is a configurational diagram illustrating the 3D capturing and recording apparatus according to a second embodiment.

FIG. 8A is a control timing chart of a SRAM according to the second embodiment (writing of data for right eye to the SRAM).

FIG. 8B is a control timing chart of the SRAM according to the second embodiment (writing of data for left eye to the SRAM).

FIG. 8C is a control timing chart of the SRAM according to the second embodiment (reading of the data for right and left eyes from the SRAM).

FIG. 9A is an image diagram illustrating transition of state of writing blocks according to the second embodiment.

FIG. 9B is an image diagram illustrating transition of state of writing blocks according to the second embodiment.

FIG. 9C is an image diagram illustrating transition of state of writing blocks according to the second embodiment.

FIG. 9D is an image diagram illustrating transition of state of writing blocks according to the second embodiment.

FIG. 9E is an image diagram illustrating transition of state of writing blocks according to the second embodiment.

### DETAILED DESCRIPTION OF PREFERRED EMBODIMENTS

### First Embodiment

A first embodiment is described below. In the first embodiment, a recording control apparatus, a semiconductor recording apparatus, and a recording system are applied to a 3D capturing and recording apparatus.

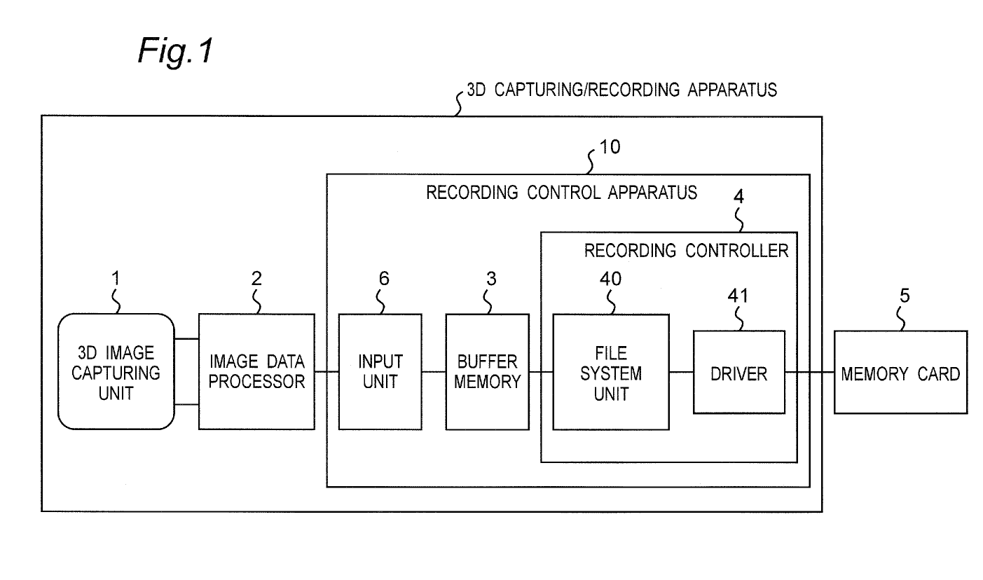

FIG. 1 illustrates configuration of the 3D capturing and recording apparatus according to the first embodiment. The 3D capturing and recording apparatus includes a 3D image capturing unit 1, an image data processor 2, a buffer memory 3 and a recording controller 4. The buffer memory 3 and the recording controller 4 are included in a recording control apparatus 10.

The 3D image capturing unit 1 is a capturing unit for a stereoscopic image data, and includes two types of imaging devices that are arranged and spaced by a length equal to a gap between a human's right and left eyes. The 3D image capturing unit 1 may have a configuration to capture and output an image for left eye and an image for right eye composing a stereoscopic image. The 3D image capturing unit 1 is not limited to the embodiment including the two types of imaging devices. For example, in the 3D image capturing unit 1, one image device may capture images for right and left eyes in a time division system to output these images.

The image data processor 2 is a unit for processing image data for right and left eye captured by the 3D image capturing unit 1, and performs intraframe compression for the image data for right and left eyes. The intraframe compression uses compressing methods such as JPEG/DV to be used in digital still cameras and camera recorders. The compressing method is not limited to the method, and thus any method may be used.

The recording control apparatus 10 processes the image data for left eye and the image data for right eye output from the image data processor 2 as different kinds of image data, respectively.

The buffer memory 3 temporarily stores the compressed image data processed by the image data processor 2 therein. While the compressed image data for one eye is being written to a memory card 5, the buffer memory 3 temporarily stores the compressed image data for the other eye therein.

The recording controller 4 includes a file system unit 40 and a driver 41. The file system unit 40 treats the compressed image data for right eye and the compressed image data for left eye as individual one file, respectively, and relates logical blocks of the memory card 5 to image data composing each file.

The memory card 5 adopts an FAT file system. FAT manages a file name of each file and positions of the logical blocks of contents of each file written to memory card. The driver 41 is a driver of the memory card 5, and issues a write command and a read command to the memory card 5.

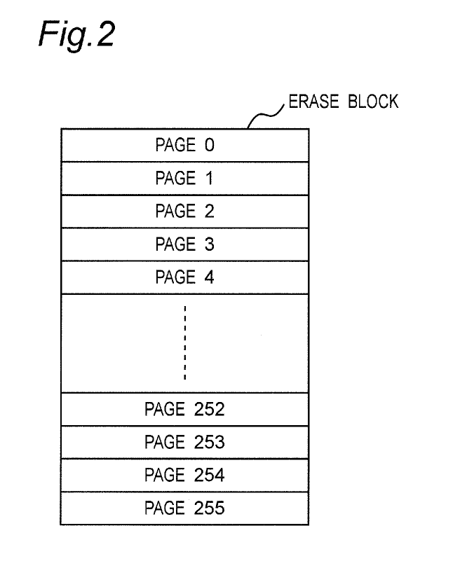

The memory card 5 includes a nonvolatile memory such as a flash memory, and a control circuit for controlling writing to the nonvolatile memory. The flash memory includes a plurality of erase blocks that is a minimum erasing unit. For example, the flash memory with capacity of 2 GB has 1024 erase blocks with size of 2 MB. The erase block includes a plurality of recording pages. FIG. 2 is a diagram illustrating a configuration of the erase blocks. Each of the erase blocks includes 256 recording pages. When the size of one recording page is 8 KB, the size of one erase block is 2 MB (=8 KB×256). When an erase block that is a target to be written data is already erased, the erasing operation is not performed on the erase block. However, when writing is performed on an erase block, which has been written with data after the erasing operation is performed on the erase block, the writing is performed on a one-recording page basis that is 8 KB.

An operation of the 3D capturing and recording apparatus having the above configuration is described in detail below.

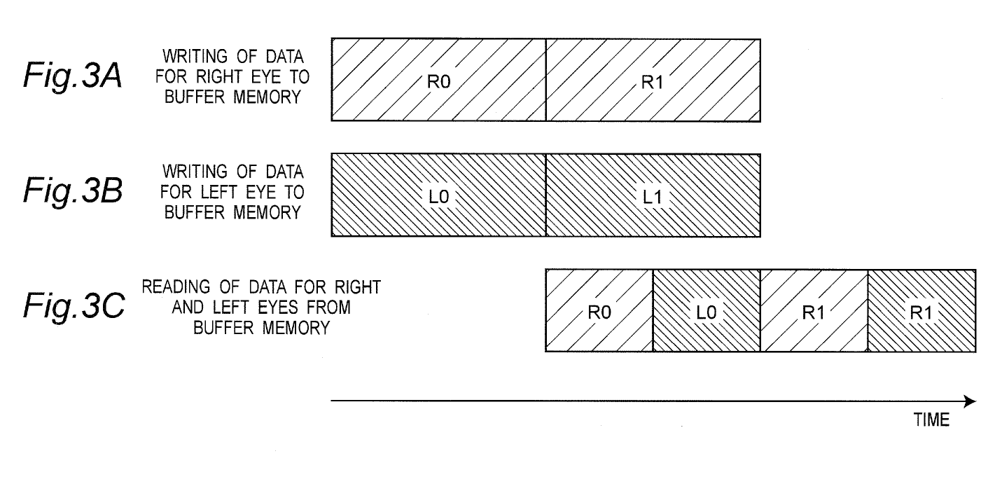

Control of the buffer memory 3 is described first. FIGS. 3A to 3C are diagrams illustrating timings of the writing and reading to/from the buffer memory 3. Concretely, FIG. 3A illustrates the timing at which compressed image data for right eye is written to the buffer memory 3, FIG. 3B illustrates the timing at which compressed image data for left eye is writing to the buffer memory 3, and FIG. 3C illustrates the timing at which the compressed image data for right and left eyes are read from the buffer memory 3.

R0 and R1 in FIGS. 3A to 3C indicate compressed image data segments obtained by dividing the compressed image data for right eye by 2 MB. L0 and L1 indicate compressed image data segments obtained by dividing the compressed image data for left eye by 2 MB.

The compressed image data are written to the buffer memory 3 at the timings shown in FIGS. 3A and 3B, the compressed image data being processed and compressed as the image for right eye and the image for left eye by the image data processor 2. The compressed image data for right and left eyes written to the buffer memory 3 are interleaved in unit of 2 MB compressed image data segment as shown in FIG. 3C, and are read from the buffer memory 3. The compressed image data segment for right eye and the compressed image data segment for left eye read from the buffer memory 3 are related to different erase blocks by the file system unit 40, respectively, in a manner not to mix them in one erase block. These compressed image data are recorded to the related erase blocks. At the time of recording, the erase blocks are related to logical blocks of the memory card 5 by using a logical/physical conversion table. The driver 41 issues a write command, so that the compressed image data is recorded to the memory card 5.

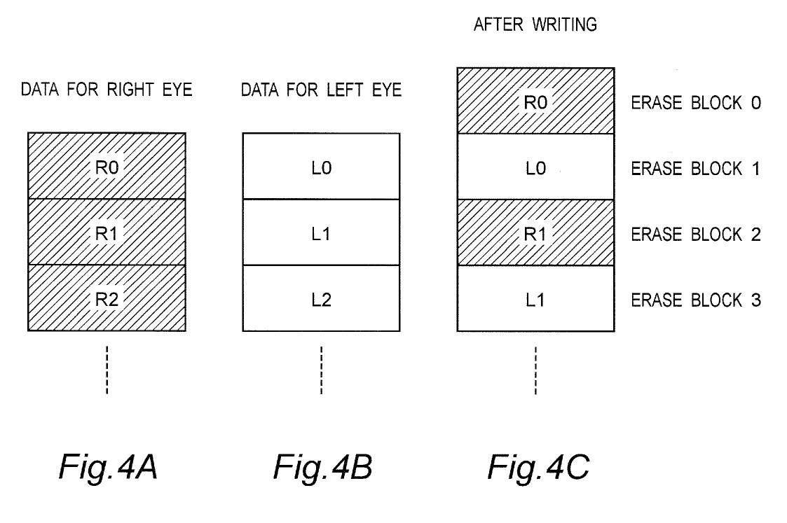

FIGS. 4A to 4C are diagrams illustrating a correspondence relationship between the compressed image data for right and left eyes and the erase blocks of the memory card 5. FIG. 4A is a conceptual diagram where the image data for right eye is divided to 2 MB. R0, R1 and R2 indicate the compressed image data segments for right eye divided to 2 MB. FIG. 4B is a conceptual diagram where the image data for left eye is divided to 2 MB. L0, L1 and L2 indicate the compressed image data segments for left eye divided to 2 MB. FIG. 4C illustrates correspondence between the erase blocks of the memory card 5 and the respective compressed image data segments of 2 MB. As shown in FIG. 4C, only one of the compressed image data for either the right eye or the compressed image data for the left eye is recorded to one erase block. That is to say, the compressed image data of the image for right eye and the image for left eyes are not recorded to one erase block in a mixed state. In FIG. 4C, the compressed image data for right and left eye are arranged alternatively in the erase blocks of the memory card, but they do not necessarily have to be arranged alternatively.

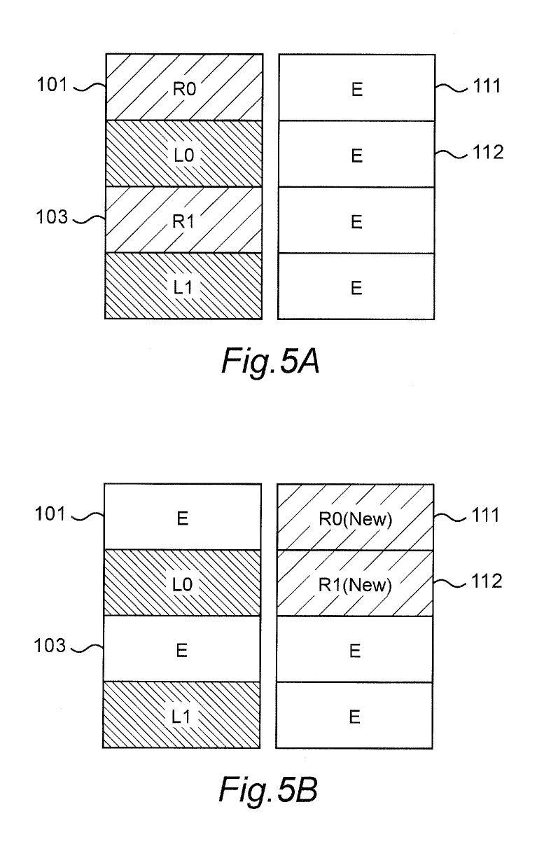

A process for editing one of the image data for right eye and the image data for left eye and writing back them in the memory card 5 storing 3D image data therein is described with reference to FIGS. 5A and 5B.

FIGS. 5A and 5B are diagrams illustrating arrangements of the image data in the memory card 5 before and after the editing. FIG. 5A illustrates the arrangement before the editing, and FIG. 5B illustrates the arrangement after the editing. In FIGS. 5A and 5B, R0 and R1 indicate the compressed image data segments for right eye arranged in the erase block, and L0 and L1 indicate the compressed image data segments for left eye arranged in the erase block. Further, E represents that no data is arranged in the erase block, namely, the erase block is in a deleted state.

An example that R0 and R1 are edited in the state of FIG. 5A and rewritten is described. After the compressed image data segments for right eye R0 and R1 are processed, as shown in FIG. 5B, the compressed image data segments R0 (New) and R1 (New) are written to the erase blocks 111 and 112 that is in the deleted state in FIG. 5A. The erase blocks 101 and 103 where the compressed image data segments for right eye R0 and R1 in FIG. 5A are brought into the deleted state as shown in FIG. 5B.

A point to which an attention should be paid is that the number of erase blocks in the erased state where no data is arranged is four, and the same number of blocks are retained before and after the editing, as shown in FIG. 5A and FIG. 5B.

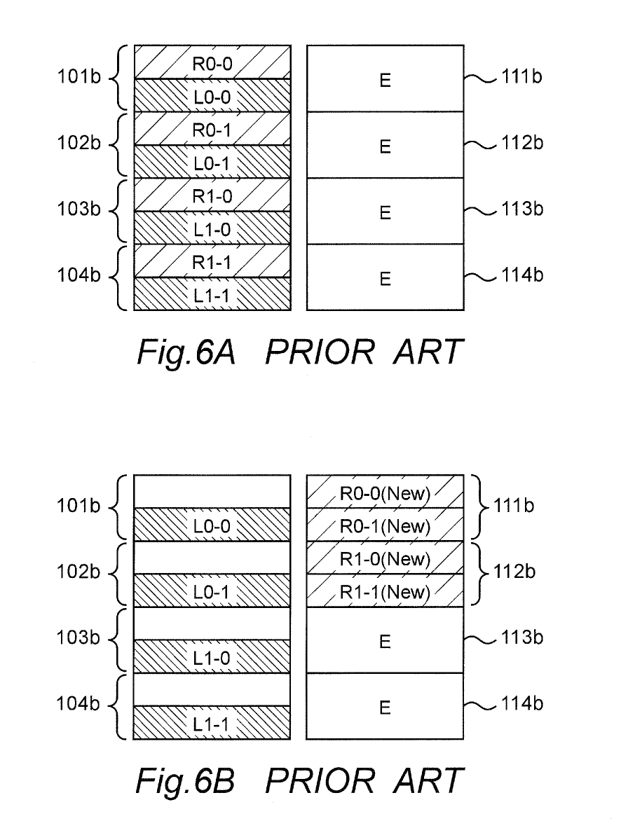

The conventional case where the compressed image data for right eye is processed and written back in the memory card in which both the compressed image data for right eye and the compressed image data for left eye are written to one erase block in a mixed state is described below with reference to FIGS. 6A and 6B.

FIGS. 6A and 6B are diagrams illustrating arrangements of the image data before and after the editing in a conventional memory card. FIG. 6A illustrates the arrangement before the editing, and FIG. 6B illustrates the arrangement after the editing. In FIG. 6A, R0-0 and R0-1 indicate the compressed image data segments that are obtained by dividing the compressed image data segment R0 of 2 MB into two by 1 MB. Similarly, R1-0, R1-1, L0-0, L0-1, L1-0 and L1-1 indicate the compressed image data segments that are obtained by dividing the compressed image data segments of R1, L0 and L1 of 2 MB into 2 by 1 MB. Further, F represents that no data is arranged in the erase block, namely, the erase block is in the erased state. As shown in FIG. 6A, each of the compressed image data for right eye and the compressed image data for left eye of 1 MB is recorded to each of the erase blocks 101b to 104b. When the data for right eye in the state of FIG. 6A is processed and written back to the memory card, the state is changed into the state of FIG. 6B.

Before the editing as shown in FIG. 6A, erase blocks in the erased state where no data is arranged are the erase blocks 111b to 114b, so that the number of than is four. After the editing as shown in FIG. 6B, erase blocks in the erased state where no data is arranged are the erase blocks 113b and 114b, so that the number of them is two. Thus the number of the erase blocks in the erased state decreases after the editing. This is because the data for left eye to be edited and the data for right eye are arranged in a mixed manner in the same erase block. In order to ensure four erase blocks in the erased state after the editing, further the data L0-0, L0-1, L1-0 and L1-1 should be read from the state of FIG. 6B, then the read data should be moved to the two erase blocks 113b and 114b in the erased state, and afterwards the data should be erased from the four erase blocks 101b to 104b from which the data is moved. In this case, the image data for left eye that is not a target for the editing is also moved between the erase blocks, and thus editing efficiency is deteriorated more greatly than the method according to the first embodiment.

In the first embodiment, individual files are provided for the image for left eye and the image for right eye in the recording controller 4. The file of the image for left eye and the file of the image for right eye are recorded to different erase blocks of the memory card 5 in a manner not to mix them in one erase block of the memory card 5. As a result, when only one of image data for right eye and image data for left eye composing a stereoscopic image is processed and edited and written back, only this image data can be read and written. Therefore, the other image data are not read and written, and this enables the efficient process and editing. Further, the erase block where the image data to be processed is recorded can be brought into the erased state without moving the image data for the other eye to another erase block. Therefore, in the 3D capturing and recording apparatus, the editing efficiency at the time of editing only one of the images for right and left eyes can be greatly improved.

In order to simplify the description in the first embodiment, the data are sequentially written to the two erase blocks of the memory card 5, but the data may be written to the two or more blocks in parallel. As a result, higher-speed writing can be realized. For example, when the number of data arranged in parallel is 2, the buffer memory 3 and the file system unit 40 may be controlled on just a two-erase block (=4 MB) basis.

The first embodiment describes the configuration where the recording controller 4 is provided in the 3D capturing and recording apparatus, but the recording controller 4 may be provided in the memory card 5.

Further, the case where the nonvolatile memory contained in the memory card 5 is a flash memory is described, but it can be widely applied to memories where units of erasure is different from unit of writing.

The first embodiment describes the case where image data to be edited is 3D image data including image data for right eye and image data for left eye. However it goes without saying that a technical idea of the first embodiment can be applied also to a case where besides the 3D image data, two or more kinds of image data that are related to each other are recorded simultaneously. For example, when four kinds of image data are recorded simultaneously, a higher-capacity buffer memory is packaged so that the equivalent effect can be obtained.

The first embodiment described the stereoscopic image, but the first embodiment can be applied also to a high-definition image including a plurality of images. For example, the first embodiment can be similarly applied to a case where a high-definition image with pixels of 7680×4320 is configured by sixteen images with pixels of 1920×1080, and these sixteen images are processed as a plurality of kinds of image data.

### Second Embodiment

In the first embodiment, the size of the erase block is MB, and thus the buffer memory of totally 8 MB including the capacity of 4 MB for writing and the capacity of 4 MB for reading is necessary for writing compressed image data for right eye and writing compressed image data for left eye to different erase blocks. That is to say, the high-capacity buffer memory is necessary.

The second embodiment, therefore, describes a configuration that the equivalent function is realized by control on the memory card side without packaging a high-capacity buffer memory.

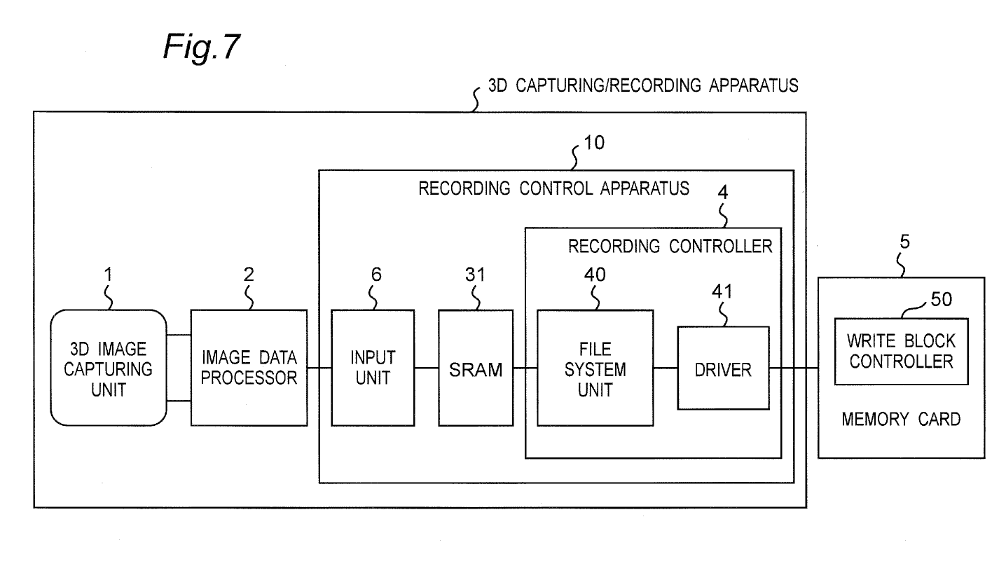

FIG. 7 is a configurational diagram illustrating the 3D capturing and recording apparatus according to the second embodiment. A difference from the first embodiment is such that the 3D capturing and recording apparatus includes a low-capacity SRAM 31 instead of the buffer memory 3 and a writing block controller 50 is added to the inside of the memory card 5. Since the same operation as that in the first embodiment is performed on the blocks having the same notations as those in FIG. 1, the description thereof is omitted.

Operations of the low-capacity SRAM 31 and the writing block controller 50 are described in detail below.

In the second embodiment, a size of the erase blocks in the memory card 5 is 2 MB that is the same as the size of the erase blocks in the first embodiment, but compressed image data for left eye and compressed image data for right eye are interleaved by 256 KB to be written to the memory card 5. For this reason, the driver 41 issues a write command for instructing such writing to the memory card 5.

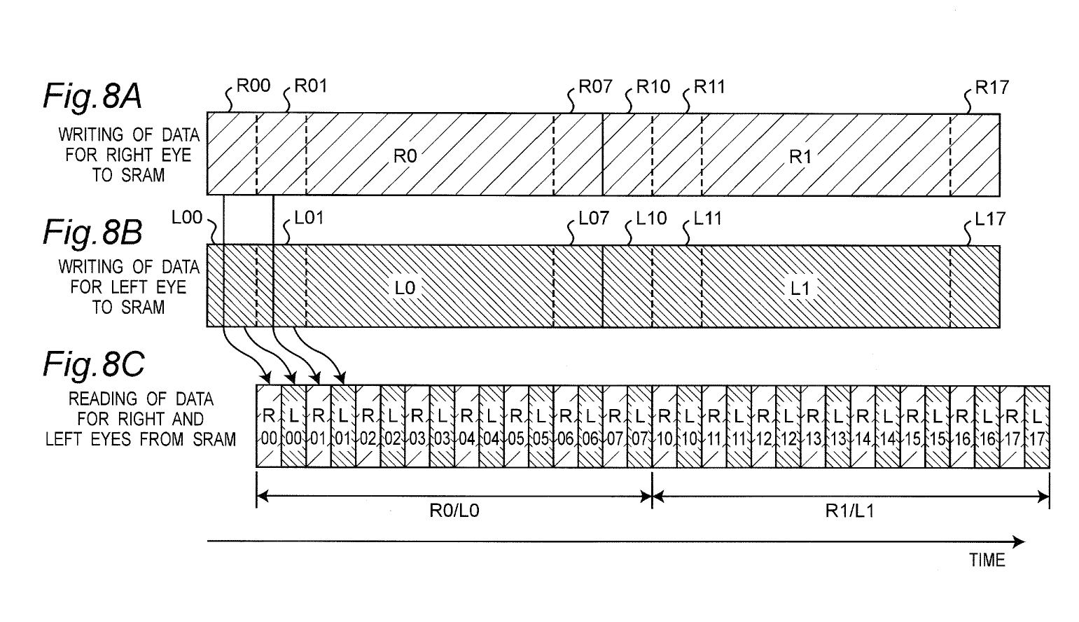

FIGS. 8A to 8C are diagrams illustrating the timings of the writing and reading to/from the SRAM 31. Concretely, FIG. 8A illustrates the timing at which compressed image data for right eye is written to the SRAM 31, FIG. 8B illustrates the timing at which compressed image data for left eye is written to the SRAM 31, and FIG. 8C illustrates the timing at which the compressed image data for left eye and the compressed image data for right eye are read from the SRAM 31.

R0 and R1 in FIG. 8A indicate compressed image data segments that are obtained by dividing the compressed image data for right eye by 2 MB. L0 and L1 in FIG. 8B indicate compressed image data segments that are obtained by dividing the compressed image data for left eye by 2 MB. R00, R01, . . . , R07 in FIG. 8C indicate compressed image data subsegments that are obtained by dividing the compressed image data segment R0 to 8. Since R0 has a size of 2 MB, R00, R01, . . . , R07 have a data size of 256 KB. Similarly, R10, R11, . . . , R17 indicate compressed image data subsegments of R1. Similarly, L00, L01, . . . , L07 indicate compressed image data subsegments of L0. Similarly, L10, L11, . . . , L17 indicate compressed image data subsegments of L1.

The image data processor 2 writes the compressed image data obtained by compressing an image for right eye and an image for left eye to the SRAM 31 at the timings shown in FIGS. 8A and 8B. As shown in FIG. 8C, the compressed image data for right eye and the compressed image data for left eye are interleaved on a basis of the compressed image data subsegment (=256 KB), and are read from the SRAM 31. For example, the compressed image data segments R0 and L0 for right eye and left eye are interleaved to be read by the compressed image data subsegments R00, L00, R01 and L01 of a 256 KB unit in this order. The compressed image data subsegments read from the SRAM 31 are related to respective different erase blocks by the file system unit 40 so that the compressed image data subsegments for right eye and the compressed image data subsegments for left eye are not mixed in one erase block. The driver 41 issues the write command, and the read compressed image data segments are recorded to the erase blocks determined in the above manner in the memory card 5. At the time of the recording, the erase blocks are related to logical blocks of the memory card 5 by using the logical-physical conversion table. In the first embodiment, after the compressed image data for right eye and the compressed image data for left eye are interleaved by 2 MB for one erase block and the compressed image data for right and left eyes for one block is written, the data is read. For this reason, the high-capacity buffer memory for two blocks (=8 MB) is required. In the second embodiment, however, when the two segments R00 (256 KB) in FIG. 8A and L00 (256 KB) in FIG. 8B are written in the SRAM 31, these data can be read from the SRAM 31. Therefore, the SRAM 31 of about 1 MB that is four times as large as 256 KB can be used. In the second embodiment, the image data subsegments are obtained by dividing the compressed image data segment into 8, but when it is divided more finely, the unit of the interleaving becomes more fine, thereby reducing the size of the SRAM. For example, when the compressed image data segment is divided into 32, the size of the compressed image data subsegment becomes 64 KB, and the size of the SRAM is 256 KB that is sufficient.

The operation of the writing block controller 50 of the memory card 5 is described below.

In general, the memory card 5 includes the logical/physical conversion table that manages the correspondence relationship between the logical blocks and the erase blocks, and a blank block table that manages use/non-use of erase blocks. When the host device (in the second embodiment, the driver 41 of the recording control apparatus 4) issues the write command, erase blocks in the erased state are allocated as new writing blocks with reference to the blank block table. The writing block is a block where the writing is permitted together with the erase block related by using the logical/physical conversion table. A size of the writing block is obtained by multiplying the size of the erase block by m. m is an integer of 1 or more. Data of one logical block is allocated to one writing block. Therefore, two erase blocks as well as the erase blocks related in the logical/physical conversion table are allocated to the logical block to which the writing block is allocated. Since latest data is written to the writing block, when this data at the same logical address are provided in both the writing block and the erase block related in the logical/physical conversion table in an overlapped manner, the data that is written to the writing block is legitimate data.

A conventional writing process is described below. When a logical block corresponding to a logical address indicated by the write command is the same as a logical block to which a writing block is already allocated, data is additionally written to this logical block (writing block). On the other hand, when a logical block corresponding to a logical address indicated by the write command is different from a logical block to which a writing block is allocated, the existent writing block is cancelled, and a new writing block is secured for the writing to the logical block indicated by the write command. The process for canceling the existent writing block is a process for aggregating the data in the writing block to be cancelled and the data in the same logical block present in another erase block to one erase block, and reflecting the erase block where the data are aggregated to the logical/physical conversion table.

In such a processing method, however, for example, when a size of a erase block is 2 MB and logical blocks are alternatively switched by 256 KB so that the write command is issued, the aggregating process is generated at every write command, and thus a writing speed is deteriorated.

In the second embodiment, the writing block controller 50 is provided to the memory card 5. The writing block controller 50 secures erase blocks, which are different from erase blocks registered in the logical/physical conversion table, as writing blocks whose number is the same as at least the number of image types based on the write command from the recording control apparatus 10, and interleaves image data segments in the respective logical blocks to record these image data segments to these writing blocks. In the second embodiment, the writing block controller 50 generates and secures two writing blocks for two kinds of images for right eye and left eye. As a result, a deterioration in the writing performance due to repetition of the aggregating process is prevented. Since the size of a logical block and a size of a erase block are 2 MB in the second embodiment, the size of a writing block is also 2 MB. When the write commands that are sequentially issued instruct the writing to the same logical blocks, data is written to an allocated first writing block. On the other hand, when the write commands that are sequentially issued instruct the writing to different logical blocks, the writing to existent writing blocks is suspended. A blank block table is searched so that a second writing block is secured, and the writing to the secured second writing block is carried out. Further, when the write command issued next is determined as a command for instructing the writing to the same logical block as the first writing block, data is additionally written to the first writing block. Since the two writing blocks are provided in such a manner, the aggregating process is not generated as long as the write command for a third logical block is not detected.

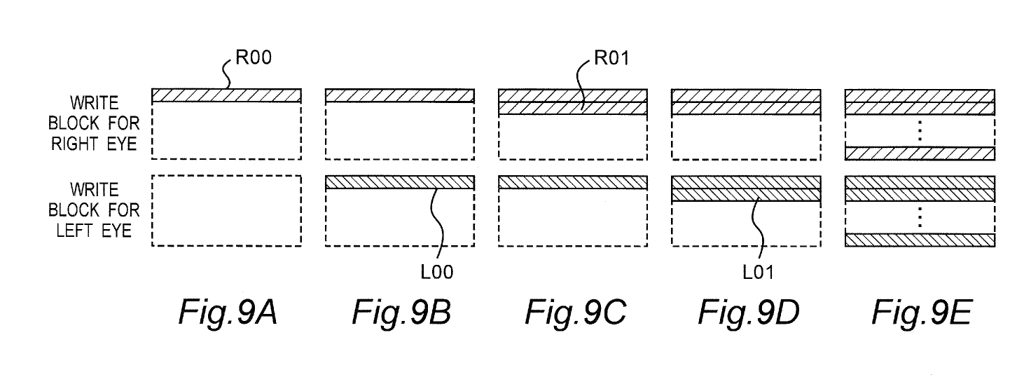

FIGS. 9A to 9E are image diagrams illustrating the writing of data to a writing block. In these drawings, an upper stage shows a writing block in which compressed image data subsegments for right eye are recorded, and a lower stage shows a writing block in which compressed image data subsegments for left eye are recorded. Concretely, FIG. 9A illustrates a state after one compressed image data subsegments for right eye R00 is written to the writing block for right eye. At this time, a writing block for recording compressed image data subsegments for left eye therein is not yet secured. FIG. 9B illustrates a state after one compressed image data subsegment for left eye L00 is written to the writing block for left eye. FIG. 9C illustrates a state after one compressed image data subsegment for right eye R01 is further written to the writing block for right eye. FIG. 9D illustrates a state after one compressed image data subsegment for left eye L01 is further written to the writing block for left eye. FIG. 9E illustrates a state of the writing block for right eye and the writing block for left eye after the writing of the compressed image data subsegments for both eyes is completed.

In FIG. 9A, when the write command for writing the compressed image data subsegment for right eye R00 to the memory card 5 is issued, a first writing block (writing block for right eye) is generated, and the compressed image data subsegment R00 is written to the first writing block.

In FIG. 9B, the write command which is issued at the time of writing the compressed image data subsegment for left eye L00 to the memory card 5 is a command for instructing the writing to a logical block (writing block) that is different from the write command issued at the last time (in FIG. 9A, the write command issued at the time of writing the compressed image data subsegment for right eye R00 to the memory card 5). For this reason, the writing block controller 50 of the memory card 5 generates a second writing block (writing block for left eye). As a result, the aggregating process is prevented from being generated.

In FIG. 9C, the write command which is issued at the time of writing the compressed image data subsegment for right eye R01 to the memory card 5 is a command for instructing the writing to a logical block that is different from the write command issued at the last time (in FIG. 9B, the write command issued at the time of writing the compressed image data subsegment for left eye L00 to the memory card 5). However, this command instructs the writing to the same logical block as the write command that is a two previous command to this command (In FIG. 9A, the write command issued at the time of writing the compressed image data subsegment for right eye R00 to the memory card 5). For this reason, the writing is additionally performed on the existent first writing block (the writing block for right eye), and the aggregating process is not generated.

The two writing blocks are set in such a manner so that the compressed image data for right eye and the compressed image data for left eye can be alternatively written in small block unit without executing the aggregating process, thereby preventing the deterioration in the writing performance due to the repetition of the aggregating process. Therefore, the capacity of the buffer memory packaged in the first embodiment can be sufficiently reduced, so that the cost of the 3D capturing and recording apparatus can be reduced.

In the second embodiment, a determination is automatically made whether target data is data for left eye or data for right eye so that the writing block is secured in the memory card 5. However, the command for writing compressed image data is issued with a tag for identifying data for left eye or data for right eye, and secureness of writing block and the writing to the writing block may be controlled based on this tag. Also in this case, the equivalent effect can be obtained.

In the second embodiment, the write commands for image data for right eye and image data for left eye are alternatively issued to the memory card, but the technical idea of the embodiment is not limited to this. For example, when the capacity of the SRAM is doubled, a capacity allowance can be obtained at the time of data writing. The write commands for the same erase block are sequentially issued, so that image data for one eye can be sequentially written. As a result, the technical idea of the embodiment can cope with a variation of the writing time in the memory card, and a more flexible system can be structured.

Similarly to the first embodiment, the second embodiment can be applied to the case where two or more kinds of image data are simultaneously recorded. Further, when N writing blocks are packaged, N more kinds (N is a natural number of two or more) of image data can be simultaneously recorded.

### INDUSTRIAL APPLICABILITY

The stereoscopic image recording apparatus according to the embodiments is effective for the case where 3D images are recorded to semiconductor media such as memory cards and the recorded 3D images are processed to be written back to the semiconductor media. Therefore, the apparatus is useful particularly for an industrial image recording field where captured 3D image data are processed and edited.

What is claimed is:

1. A recording control apparatus comprising:
an input unit operable to input plural kinds of image data composing a stereoscopic image or a high-definition image; and
a recording controller operable to control recording of the plural kinds of image data input by the input unit, to a nonvolatile storage medium,
wherein the recording controller controls the recording so that the plural kinds of image data input by the input unit are recorded to different erase blocks of the nonvolatile storage medium in such a manner that different kinds of image data are not mixed in one erase block of the nonvolatile storage medium.

2. The recording control apparatus according to claim 1, further comprising:
a buffer memory for simultaneously storing the plural kinds of image data input by the input unit,
wherein the recording controller includes a file system unit operable to divide each of the image data on the buffer memory into image data segments with predetermined size and relate the divided image data segment to at least one erase block of the nonvolatile storage medium.

3. The recording control apparatus according to claim 2, wherein the recording controller includes a driver unit operable to divide the image data segment into a plurality of subsegments each of which size is smaller than the erase block, and issue, to the nonvolatile storage medium, a write command for instructing recording of the each divided subsegment into the nonvolatile storage medium sequentially.

4. The recording control apparatus according to claim 2, wherein the recording controller includes a driver unit operable to divide the image data segment of each of the plural kinds of image data into a plurality of subsegments, and issue, to the nonvolatile storage medium, a write command for instructing interleaving of the divided subsegments for each kind of images and recording the divided subsegments to the nonvolatile storage medium.

5. The recording control apparatus according to claim 1, wherein the plural kinds of image data include image data for a left eye and image data for a right eye composing a stereoscopic image.

6. The recording control apparatus according to claim 1, wherein the plural kinds of image data are image data that are simultaneously captured.

7. A semiconductor recording apparatus, comprising:
an input unit operable to input a plural kinds of image data composing a stereoscopic image or a high-definition image; and
a recording controller operable to control recording of the plural kinds of image data input by the input unit, to a nonvolatile storage medium,
wherein the recording controller controls the recording so that the plural kinds of image data input by the input unit are recorded to different erase blocks of the nonvolatile storage medium in such a manner that different kinds of image data are not mixed in one erase block of the nonvolatile storage medium.

8. The semiconductor recording apparatus according to claim 7, wherein the plural kinds of image data include image data for a left eye and image data for a right eye composing the stereoscopic image.

9. A recording system having a recording control apparatus and a nonvolatile storage medium, wherein
the recording control apparatus includes,
an input unit operable to input plural kinds of image data composing a stereoscopic image or a high-definition image,
a buffer memory operable to simultaneously store the plural kinds of image data input by the input unit, and
a recording controller operable to control recording of data stored in the buffer memory to the nonvolatile storage medium;
the recording controller includes,
a file system unit operable to divide each of the image data on the buffer memory into image data segments with a predetermined size and relating the divided image data segments to at least one erase block of the nonvolatile storage medium, and
a driver unit operable to divide the image data segments of the plural kinds of image data into a plurality of subsegments, and issue, to the nonvolatile storage medium, a write command for instructing interleaving of the divided subsegments for each kind of images and recording the divided subsegments to the nonvolatile storage medium;
the nonvolatile storage medium includes,
a logical/physical conversion table operable to show a correspondence relationship between logical blocks in which the image data segments are recorded and erase blocks, and
a write block controller for secure erase blocks different from erase blocks already registered in the logical/physical table as write blocks of which number is at least the same as the number of the image types based on the write command from the recording control apparatus, and interleave image data segments and record the image data segments of the respective logical blocks to these writing blocks.

10. A nonvolatile storage medium in which plural kinds of image data composing a stereoscopic image or a high-definition image are recorded in different erase blocks of the nonvolatile storage medium in a manner not to mix them in one erase block of the nonvolatile storage medium.
